(19) United States
(12) Patent Application Publication
(10) Pub. No.: US 2012/0117881 A1
(43) Pub. Date: May 17, 2012

(54) DOOR GLAZING ASSEMBLY

(75) Inventors: Daniel R. SEYMOUR, Plainville, CT (US); Michael Arthur Salvietti, Northfield, CT (US); Vito A. Spinelli, Shelton, CT (US); Michael A. Zabbo, East Windsor, CT (US)

(73) Assignee: STANLEY BLACK & DECKER, INC., New Britain, CT (US)

(21) Appl. No.: 12/948,543

(22) Filed: Nov. 17, 2010

(51) Int. Cl. E05D 15/10; E06B 7/23; E06B 7/16

(52) U.S. Cl. 49/130

(57) ABSTRACT

A door assembly includes a fixed door panel constructed and arranged to be fixed in a door opening and a sliding door panel constructed and arranged to be slidably movable relative to the fixed door panel between (1) a closed position and (2) an open position. Each door panel includes a glass panel, and a frame including a vertical frame member constructed and arranged to surround at least a portion of the vertical edge of the glass panel. At least one of the vertical frame members includes an end portion having an angled surface extending inwardly towards the glass panel. As a result of movement of the sliding door panel, the end portion of the at least one vertical frame member at least partially overlaps another of the vertical frame members.

### BACKGROUND OF THE INVENTION

1. Field of the Invention

The present invention relates to sliding door assemblies.

Door assemblies with sliding door panels are installed in many environments (e.g., in commercial buildings), where sliding door panels are configured to automatically slide open and close in order to provide easy access to premises and avoid congestion in high traffic environments.

Sliding door assemblies generally include at least one fixed or non-sliding door panel mounted thereto and one, two or more sliding door panels that move in a generally rectilinear manner between opened and closed positions. During normal operation, a power-operated door operator moves the sliding door panel(s) between the opened and closed positions thereof.

The present invention provides several improvements over the prior art.

### SUMMARY OF THE INVENTION

One aspect of the present invention provides a door assembly that includes a fixed door panel constructed and arranged to be fixed in a door opening and a sliding door panel constructed and arranged to be slidably movable relative to the fixed door panel between (1) a closed position wherein the sliding door panel covers at least a portion of the door opening to prevent passage through the door opening and (2) an open position wherein the sliding door panel is in an overlapping relationship with the fixed door panel in a manner that permits passage through the door opening. Each door panel includes a glass panel and a frame that includes a vertical frame member constructed and arranged to surround at least a portion of the vertical edge of the glass panel. At least one of the vertical frame members includes an end portion having an angled surface extending inwardly towards the glass panel. As a result of movement of the sliding door panel, the end portion of the at least one vertical frame member at least partially overlaps another of the vertical frame members.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated can be considered are drawn to scale. It is to be expressly understood, however, that the drawings are for the purpose of illustration and description only and are not intended as a definition of the limits of the invention. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 is a front perspective view of a door assembly mounted across an opening of a wall in accordance with an embodiment of the present invention;

FIG. 2 is a top view of the door assembly mounted across the opening of the wall (with track removed for clarity of illustration), when the sliding door panels are in a closed position, in accordance with an embodiment of the present invention;

FIG. 3 is a top schematic view of the door assembly mounted across the opening of the wall (with track removed for clarity of illustration), when the sliding door panels are in an open position, in accordance with an embodiment of the present invention;

FIG. 4 is a top cross-sectional view of the door assembly illustrating a fixed door panel and a sliding door panel in accordance with an embodiment of the present invention;

FIG. 5 is an exploded perspective view of the vertical frame member shown in FIG. 4 with a gasket member disposed therein;

FIG. 6 is a detailed cross-sectional view of the (fixed or sliding) vertical door panel frame of the door assembly shown in FIG. 4;

FIGS. 7-9 are cross-sectional views of the door assembly shown in FIG. 4, wherein the sliding door panel is being slidably moved relative to the fixed door panel from a closed position to an open position in accordance with an embodiment of the present invention;

FIGS. 10-14 are cross-sectional views of the door assembly illustrating the procedure in which as a result of movement of the sliding door panel, end portion of the at least one vertical frame member at least partially overlaps another of the vertical frame members in accordance with an embodiment of the present invention;

FIG. 15 illustrates cross-sectional view of the door assembly in which the fixed door panel and the sliding door panel of the door assembly arc in a fully overlapping configuration (i.e., when the sliding door panel is in an open position) in accordance with an embodiment of the present invention;

FIGS. 16-18 show portions and dimensions of various parts of an exemplary frame in accordance with an embodiment of the present invention; and

FIG. 19 shows portions and dimensions of various parts of an exemplary gasket member in accordance with an embodiment of the present invention.

### DETAILED DESCRIPTION OF THE INVENTION

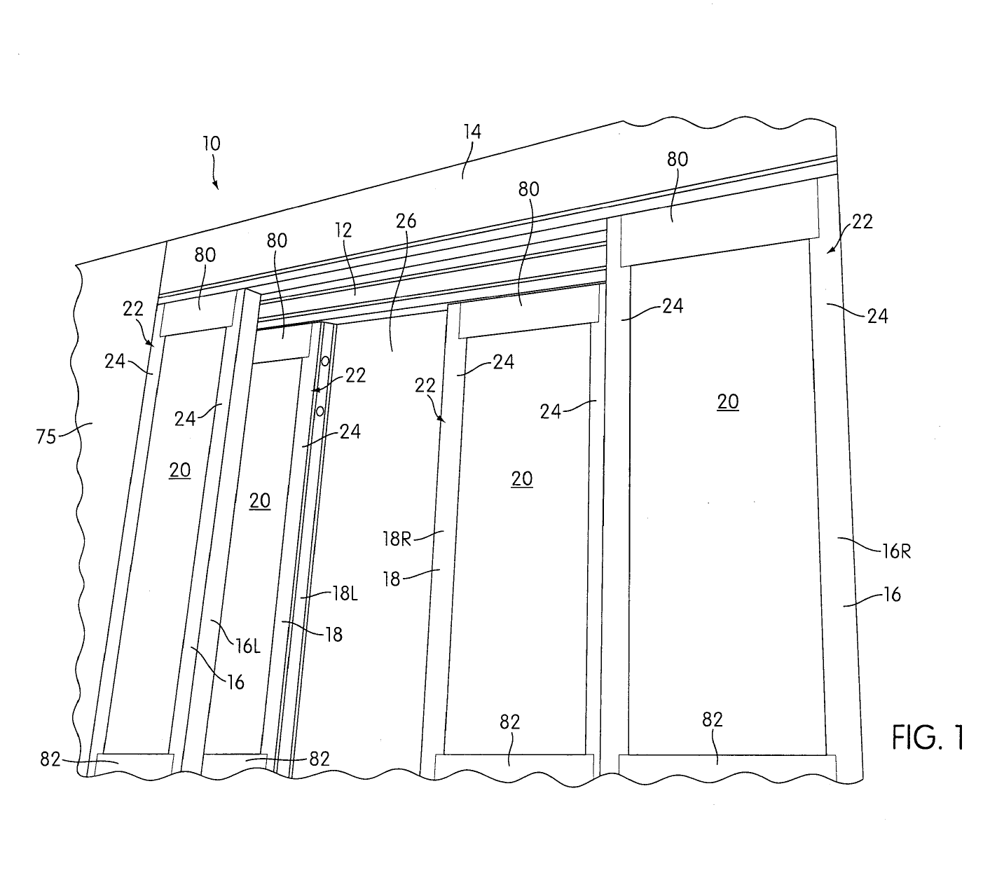

FIGS. 1-4 show a door assembly 10 in accordance with an embodiment of the present invention. The door assembly 10 includes a fixed door panel 16 constructed and arranged to be fixed in a door opening 26 and a sliding door panel 18 constructed and arranged to be slidably movable relative to the fixed door panel 16 between (1) a closed position wherein the sliding door panel 18 covers at least a portion of the door opening 26 to prevent passage through the door opening 26 and (2) an open position wherein the sliding door panel 18 is in an overlapping relationship with the fixed door panel 16 in a manner that permits passage through the door opening 26.

Referring to FIGS. 1-4, each door panel 16 or 18 includes a glass panel 20 and a frame 22 that includes a pair of vertical frame members, including at least one vertical frame member 24 of the type disclosed below. The vertical frame member 24 is constructed and arranged to surround at least a portion of the vertical edge 28 of the glass panel 20. At least one of the vertical frame members 24 includes an end portion 30 having an angled surface extending inwardly towards the glass panel 20. As a result of movement of the sliding door panel 18, the end portion 30 of the at least one vertical frame member 24 at least partially overlaps another of the vertical frame members 24.

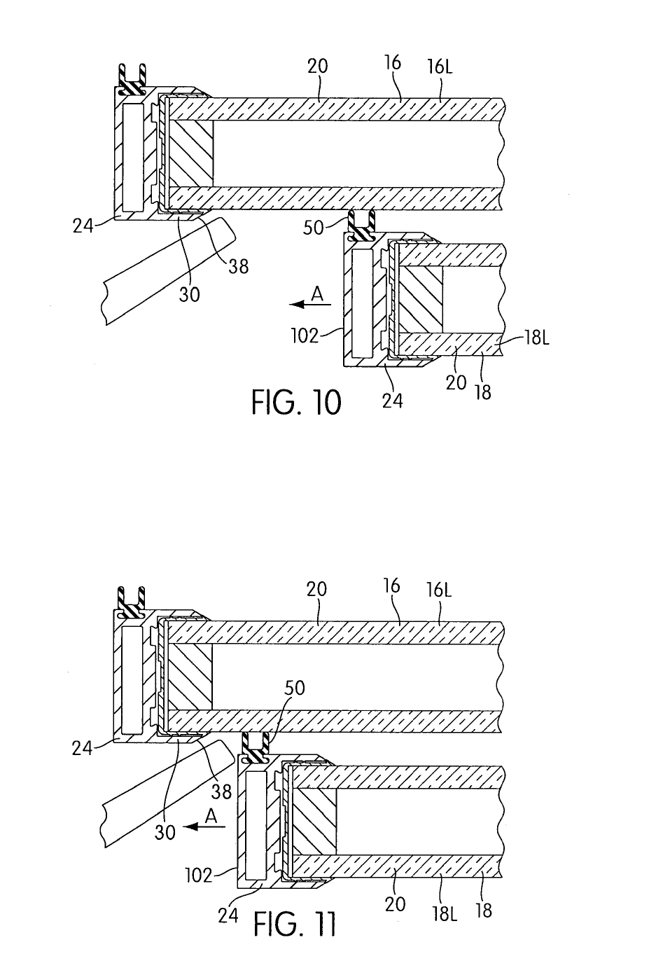

As shown in FIGS. 10-14, when the vertical frame member 24 of the sliding door panel 18 at least partially overlaps a portion of the vertical frame member 24 of the fixed door panel 16, the end portion 30 of at least one of the vertical frame member 24 is constructed and arranged to prevent the formation of a pinch point between the door panels 16 and 18.

FIGS. 1 to 3 show the door assembly 10 having four door panels, that is, left fixed door panel 16L, right fixed door panel 16R, left sliding door panel 18L and right sliding door panel 18R.

The door assembly 10 shown in FIGS. 1-3, and the number of fixed and sliding panels, is intended to be exemplary and not limiting. For example, it should be appreciated that while the present invention is described in relation to a door assembly having two door panels or four door panels, the present invention applies equally to a door assembly that includes six door panels having a fixed panel and two sliding panels on each (i.e., right and left) side of the door assembly. That is, the six door panel assembly includes three door panels located on each side (i.e., a left side and right side) of the door assembly. It is also contemplated that the embodiments of the present invention apply equally to a door assembly having a three door panels (i.e., the door assembly with only one set of three door panels instead of two sets of three door panels where each set located on each side of the door assembly).

The three-door panel construction (i.e., the fixed door panel and two sliding door panels) of the door assembly allows for a larger opening in comparison to a two-panel configuration, so as to permit wider access therethrough when the two sliding door panels are slid into the open position (i.e., where the two sliding door panels are in a compact, overlapping relationship with each other) because each door panel of the three-door panel door assembly 10 has a smaller width than the door panels of a door assembly with a two-door panel structure (i.e., having a fixed door panel and a sliding door panel to cover the same sized opening).

Also in the six door panels assembly, as the two sliding door panels are sliding from the closed position to the open position (i.e., where the two sliding door panels are in a compact, overlapping relationship with each other), the outermost sliding door moves twice as fast as the middle sliding door so that the middle sliding door and outermost sliding door are constructed and arranged to arrive in an overlapping relation to the fixed door panel at the same time. In other words, the sliding movement of the middle sliding door and the outermost sliding door of the six door panels assembly is a parallel movement (i.e., both the sliding panels moving at the same time but at a different speed) rather than a serial movement (i.e., the middle sliding door panel slides after the outermost sliding door panel). Such the six door panel assembly is disclosed in U.S. application Ser. No. 12/719,540 (“the '540 application”) to Salvietti et al., entitled “Sliding Door With Large Opening,” which is hereby incorporated by reference in its entirety. The door panels and/or door frame members disclosed herein can be in the door panels of the '540 application, and the '540 application is hereby incorporated in full for all its teachings.

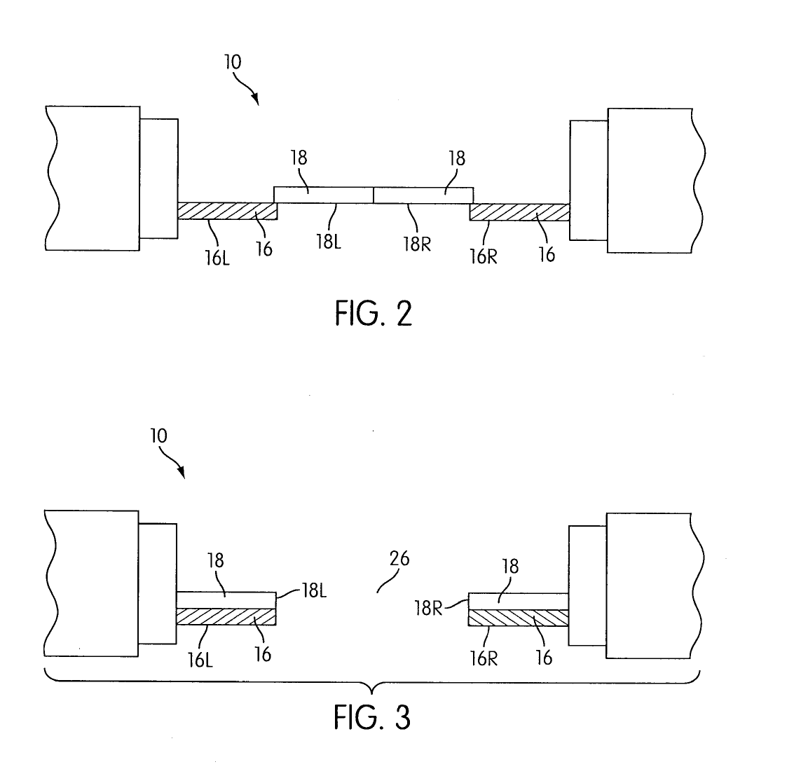

FIG. 1 shows the perspective view of the door assembly 10 mounted across the door opening 26 of the wall 75, when the sliding door panel 18 is in an intermediate position, which is a position in between the closed position (i.e., the sliding door panel 18 covers at least a portion of the door opening 26 to prevent passage through the door opening 26 as shown in FIG. 2) and the open position (i.e., the sliding door panel 18 is in an overlapping relationship with the fixed door panel 16 in a manner that permits passage through the door opening 26 as shown in FIG. 3).

FIG. 2 shows the top view of the door assembly 10 mounted across the door opening 26 of the wall 75, when the sliding door panel 18 is in the closed position. Specifically, the sliding door panel 18 is shown occupying the door opening 26 of the wall 75. The sliding door panel 18, when in the closed position, is constructed and arranged to substantially cover the door opening 26 to prevent passage through the door opening 26.

FIG. 3 shows the top view of the door assembly 10 mounted across the door opening 26 of the wall 75, when the sliding door panel 18 is in the open position. The sliding door panel 18, when in the open position, is constructed and arranged to be in an overlapping relationship with the fixed door panel 16 in a manner that permits passage through the door opening 26.

Referring to FIGS. 2 and 3, the left and right sliding door panels 18L and 18R, respectively, are disposed in an adjacent aligned relationship when in a closed position covering an enlarged door opening 26. Upon a sensor detecting an individual approaching the doorway, the left and right sliding door panels 18L and 18R move away from one another in opposite linear directions to expose the door opening 26 therebetween. The left and right sliding door panels 18L and 18R would then return to the closed position after a predetermined period.

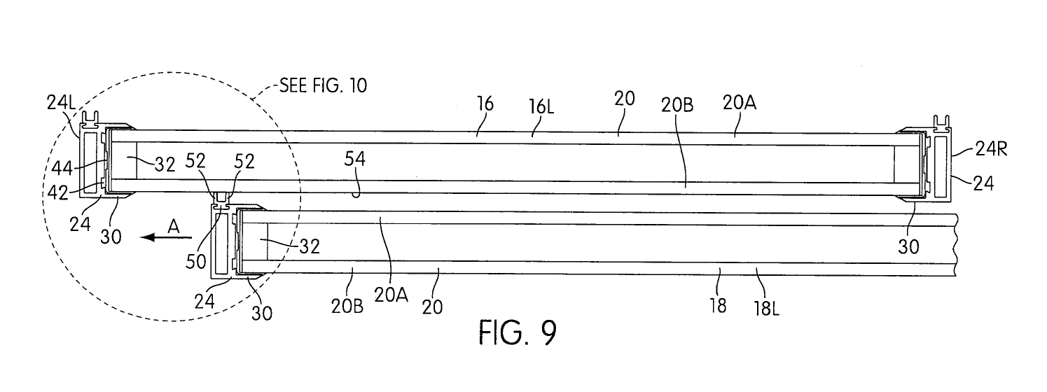

In normal operation of the sliding door panels 18, when a motion sensor (as known in the art) detects an individual approaching the doorway, a door opening signal is generated and input to a controller or processor (not shown), which in turn generates a signal to drive the motor. The motor operates to slide the sliding door panel 18L leftward and the sliding door panel 18R rightward (when oriented as in FIG. 2) such that the sliding door panels 18L and 18R are moved (generally continuously) from the closed position covering the door opening 26, through an intermediate position (as shown in FIGS. 1 and 7-10), and then to the open position (as shown in FIGS. 3 and 15), thereby permitting egress through the opening.

After a predetermined period of time, the controller generates a door closing signal to cause the motor to return the sliding door panels 18L and 18R to the closed position of FIG. 2. The aforementioned sensor for sensing the presence of an individual may optionally be of the type disclosed in U.S. Pat. No. 7,042,492 (“the '492 patent”) to Spinelli, entitled “Automatic Door Assembly with Video Imaging Device,” which is hereby incorporated by reference in its entirety, although any type of sensing system can be used. The controller may also include the sliding door control functionality disclosed in the '492 patent to control opening and closing sliding movement of the door panels.

In one embodiment, sensors are mounted at the leading and trailing edges of the sliding door panels 18L and 18R to sense whether an obstacle or traffic has cleared. These sensors may include infra-red sensor, for example, mounted at the leading and trailing edges of the sliding door panels 18L and 18R to ensure that the sliding door panels 18L and 18R do not inadvertently close. These sensors are configured to sense the presence of traffic in the doorway and to prevent the sliding door panels 18L and 18R from closing until the traffic has cleared the entranceway.

In one embodiment, each sliding door panel 18 is generally mounted on sliding panel carrier fitted into an upper portion of the sliding door panel. The sliding panel carrier is slidably received within or on a track 12 (as shown in FIG. 1) to slidably move the sliding door panel 18 on the track 12. In one embodiment, the sliding panel carrier may be mounted in the track 12 on rollers, bearings wheels or other mounting mechanisms known in the art that permit the sliding panel carrier to slide generally linearly along the track 12. The door assembly 10 further includes a track header 14 (as shown in FIG. 1) constructed and arranged to be mounted with respect to the door opening 26 formed through the wall 75 to which the door assembly 10 is installed. In one embodiment, the drive mechanism is mounted on the track header 14.

In one embodiment, the fixed door panel 16 is constructed and arranged to be releasably fixed in the door assembly 10. That is, in one embodiment, the fixed door panel 16 and the sliding door panel 18 can be pivoted from a normal configuration to a breakaway configuration. When positioned in the breakaway configuration, the door panels 16 and 18 are constructed and arranged to uncover the door opening 26 that the sliding door panel 18 and the fixed door panel 16 cover when the door assembly is installed to thereby enable access therethrough. In one embodiment, this pivoting may take place when the sliding door panel 18 is in the closed position (as shown in FIG. 2), in the open position (as shown in FIG. 3), or in an intermediate position (as shown in FIGS. 1, and 7-10) therebetween (and even when the sliding door panel is moving). It should be appreciated, however, in another embodiment this pivoting may take place only when the sliding door panel is in the normal, fully open position and may be otherwise prevented from being pivoted to the breakaway configuration. A door assembly having such breakaway configuration is disclosed in the '540 application, which is hereby incorporated by reference in its entirety.

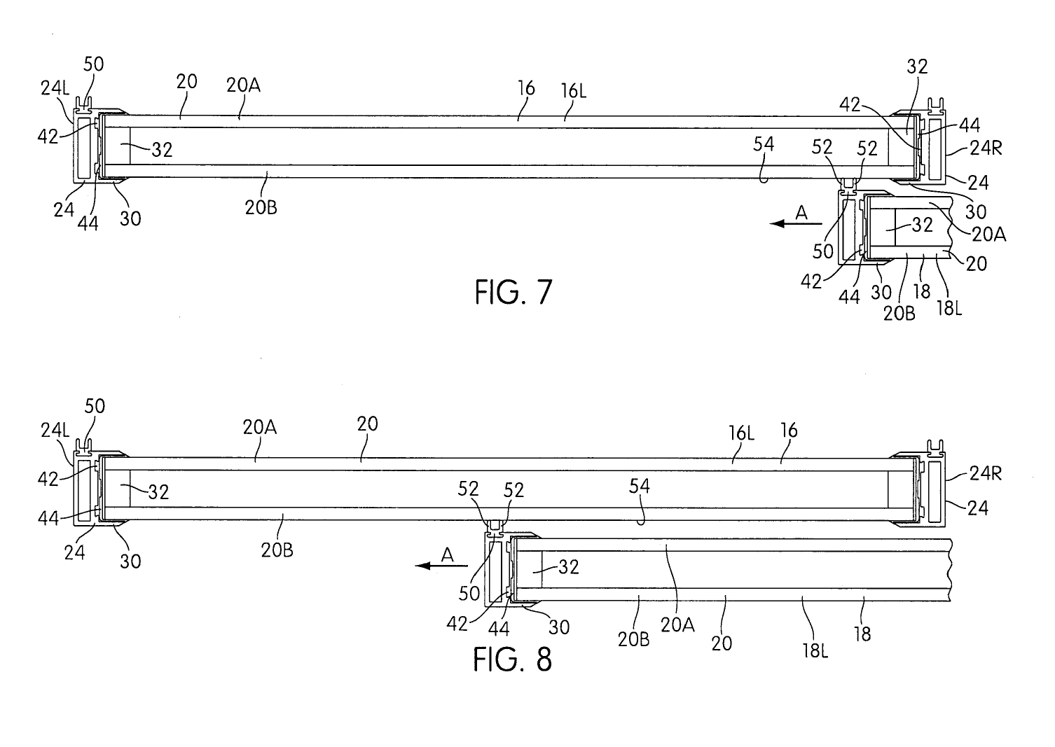

As noted above, in one embodiment, the sliding door panel 18 is constructed and arranged to generally rectilinearly move between the open position and the closed position when the door assembly 10 is installed. The door assembly 10 further includes a drive mechanism (not shown) that is constructed and arranged to drive the sliding door panel 18 between the closed position and the open position. In one embodiment, the drive mechanism includes a motor, a belt system, and a connecting member, wherein the connecting member is constructed and arranged to securely connect the sliding door panel 18 to the belt system to facilitate linear movement of the sliding door panel 18 in a direction of sliding A (as shown in FIGS. 7-13). It is contemplated that any power-operated door controlling unit or drive mechanism may be operatively connected to the sliding door panel 18 to control the opening and closing movements of the sliding door panel 18.

It should be appreciated that while the details provided above in FIGS. 1-3 are described in relation to a door assembly having two door panels on each side of the door assembly 10, the present invention applies equally to a door assembly having two door panels (i.e., the door assembly with only one set of two door panels instead of two sets of two door panels where each set located on each side of the door assembly).

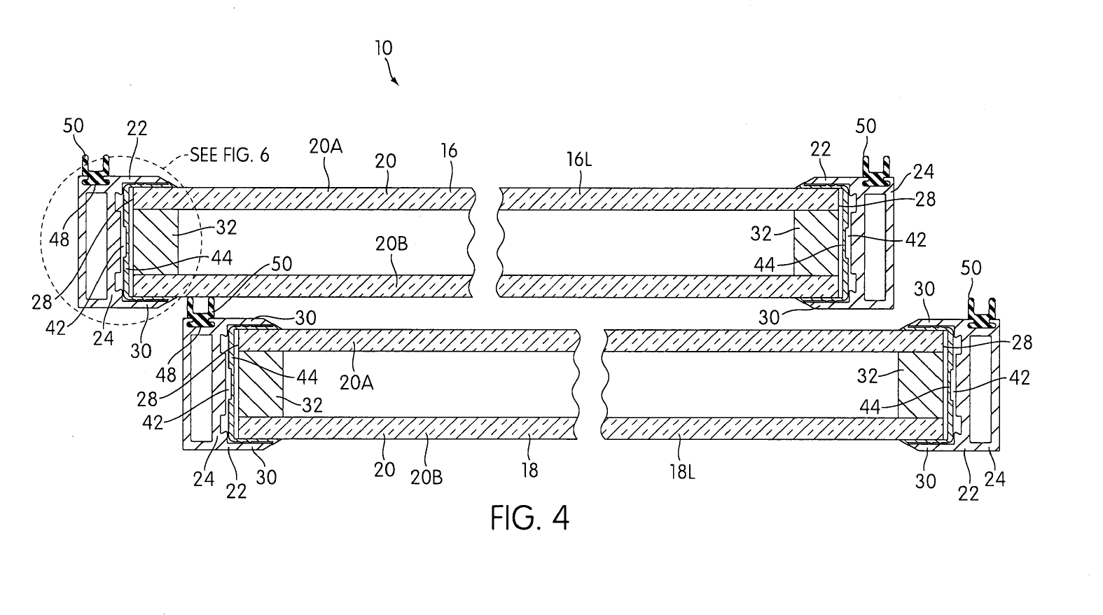

FIGS. 4, and 7-15 show only the left fixed door panel 16L and the left sliding door panel 18L of the door assembly 10 to describe the embodiments of the present invention. However, it is contemplated that the embodiments of the present invention apply equally to the right fixed door panel 16R and the right sliding door panel 18R.

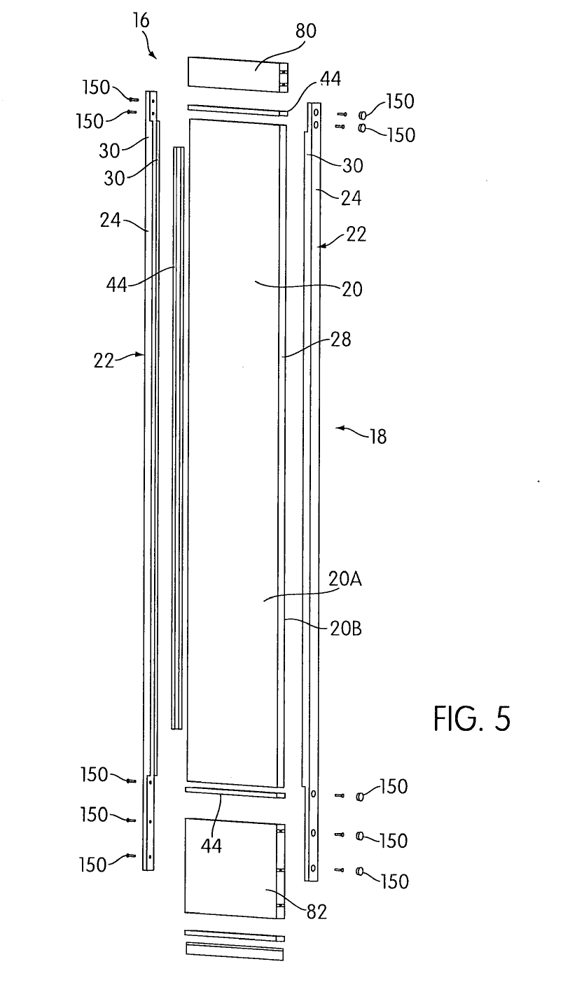

In one embodiment, as shown in FIG. 5, each (fixed or sliding) door panel 16 or 18 includes the frame 22. The frame 22 includes two spaced parallel vertically extending frame members 24, an upper frame member 80 and a lower frame member 82. These vertical frame members 24 are interconnected at their upper and lower ends by the upper frame member 80 and the lower frame member 82, respectively. In one embodiment, the vertical frame members 24 are interconnected with the upper and lower frame member 80 and 82 by any suitable fastener members 150 well known in the art.

In one embodiment, these frame components (i.e., the vertical frame members 24, the upper frame member 80 and the lower frame member 82) are made from a metal material. Such metal materials may include, but not limited to, aluminum, aluminum alloys, magnesium, or magnesium alloys. In one embodiment, these frame components are made up of extrusions of light metal material.

Each (fixed or sliding) door panel 16 or 18 generally includes one or more glass panels 20. In the illustrated embodiment, as shown in FIG. 4, each door panel 16 or 18 includes two glass panels 20A and 20B surrounded by the frame 22. That is, the vertical frame members 24, the upper frame member 80 and the lower frame member 82 are constructed and arranged to mount the glass panels 20A and 20B. In another embodiment, instead of mounting glass panels, the vertical frame members 24, the upper frame member 80 and the lower frame member 82 constructed and arranged to mount central panels made from opaque materials, such as plastic material, a metal material or a wood material.

The glass panels 20A and 20B are separated by a spacer member 32. The spacer member 32 functions as an insulator to seals the interior space between the two glass panels 20A and 20B. In the illustrated embodiment, the spacer member 32 has a rectangular cross-sectional configuration. However, it is contemplated that the spacer member having other cross-sectional configurations may be used in various embodiments of the present invention. The spacer member 32 may be made from any material including, but not limited to, a plastic material or a metal material. In another embodiment, the spacer member 32 is made from a structural foam material.

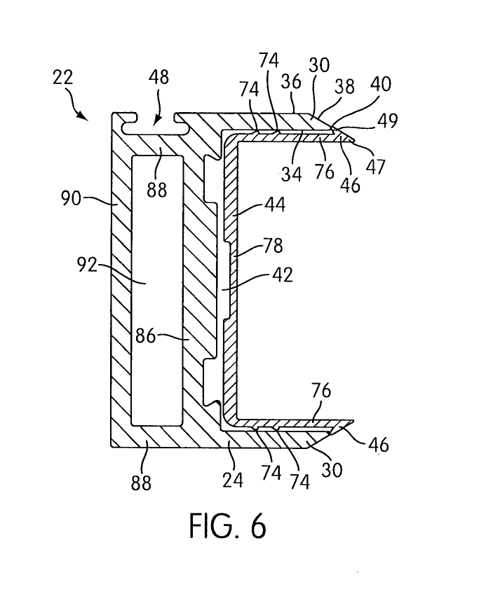

FIG. 6 illustrates a detailed cross-sectional view of one of the vertical frame members 24 (in which for clarity of illustration certain features (including the glass panel 20) are removed) in accordance with an embodiment of the present invention. Referring to FIGS. 4-6, the vertical frame member 24 includes two parallel elongated “arms” or end portions 30 interconnected along one edge by an integral cross member 86. The vertical frame member 24 also includes two integral parallel connector portions 88 interconnected along one edge by the integral cross member 86 and along the opposite edge by an integral cross member 90. In one embodiment, the two integral parallel portions 88 when interconnected with the integral cross member 86 and the integral cross member 90 define a rectangular cross-sectional space 92 therebetween. In one embodiment, the rectangular cross-sectional space 92 is configured to provide strength to the vertical frame member 24. In another embodiment, the vertical frame member 24 may not include the space 92 and instead may include a solid, integral cross member (along with the end portions 30). That is, the integral parallel portions and the integral cross members of the vertical frame member are formed together as a single, solid integral member. In one embodiment, the vertical frame member 24 is formed as a single, integrally formed structure, for example, by an extrusion process (e.g., extruded aluminum). In other embodiments, the vertical frame member 24 is formed from different parts that are joined (e.g., welded) together.

The angled end portion 30 includes a first surface 34 that is adjacent the glass panel 20 and an opposing second surface 36 that is separated from the first surface 34 by a selected distance (i.e., by the thickness of the end portion 30). The two surfaces 34 and 36 are connected by an angled surface 38.

In one embodiment, a distance between the first surface 34 and the opposing second surface 36 is less than 0.1 inch. In one embodiment, the distance between the first surface 34 and the opposing second surface 36 is 0.075 inch (which would define the thickness of the end portion 30).

In one embodiment, the angled surface 38 is oriented at an acute angle (i.e., less than 90 degrees) with respect to the first surface 34. In one embodiment, the angle between the angled surface 38 and the first surface 34 is between 10 and 45 degrees. In another embodiment, the angle between the angled surface 38 and the first surface 34 is between 20 and 40 degrees. In one embodiment, the angle between the angled surface and the first surface is about 30 degrees.

In one embodiment, the angled end portion 30 further includes a rounded corner portion 40 at an intersection between the angled surface 38 and the first surface 34. In one embodiment, the radius of curvature of the rounded corner portion 40 is between 0.003 and 0.04 inches. In another embodiment, the radius of curvature of the rounded corner portion 40 is between 0.005 and 0.02 inches. In one embodiment, the radius of curvature is about 0.01 inches. In one embodiment, instead of having radius, the corner portion is pointed (without radius of curvature) or is a flat ended surface.

In one embodiment, the end portions 30 and the cross member 86 define a generally U-shaped channel 42 that is constructed and arranged to receive a gasket member 44 therein.

In one embodiment, the gasket member 44 is constructed and arranged to be disposed between the glass panel 20 (as shown in FIGS. 4 and 5) and the vertical frame member 24. In one embodiment, the gasket member 44 has a generally U-shaped cross-sectional configuration to receive the glass panel 20 therein. In one embodiment, the gasket member 44 is adapted to wrap around or surround at least a portion of the vertical edges 28 of the glass panel 20. In one embodiment, the gasket member 44 is configured to protect the glass panel 20 (on all of its edges) from coming in contact with the frame member 24.

In one embodiment, as shown in FIG. 6, the gasket member 44 may be integrally formed as a U-shaped member. That is, the gasket member 44 may include (two) side legs 76 with a bight or cross portion 78 connecting the side legs 76. In other embodiments, the gasket member 44 may include only (two) side legs 76 with no bight or cross portion therebetween. In such embodiment, the (two) side legs 76 are formed as two separate pieces.

In one embodiment, the gasket member 44 is made from a material that is pliable enough to be wrapped around the glass panel 20. In one embodiment, the gasket member 44 is made from any material, but not limited to, a Thermoplastic Rubber (TPR) material or a Thermoplastic Elastomer (TPE) material. In another embodiment, the gasket member 44 is made from a material having oil and/or chemical resistance properties. In another embodiment, the gasket member 44 is made from a material that can withstand a temperature range of −50° F. to 150° F.

In one embodiment, referring to FIG. 6, the two end portions 46 of the gasket member 44 are constructed and arranged to extend outwardly and partially engage with the angled end portions 30 of the vertical frame member 24. In one embodiment, the end portion 46 includes a first portion 47 and a second portion 49 extending away from the first portion 47. In one embodiment, the second portion 49 of the end portion 46 is constructed and arranged to partially engage with the (rounded) corner portion 40 of the angled end portion 30. That is, in one embodiment, the second portion 49 of the end portion 46 wraps around the corner portion 40 of the vertical frame member. The first portion 47 of the end portion 46 generally lies adjacent to the glass 20 (received in the channel 42). The gasket member 44, thus, provides a transition between the metal portion of the vertical frame member 24 and the glass 20 that is received in the channel 42.

In some embodiments, the gasket member 44 may also be configured to reduce noise, provide an airtight and water tight seal and improve friction between the glass panel 20 and the vertical frame member 24. In one embodiment, the gasket member 44 may include protruding portions 74 that are constructed and arranged to frictionally engage the inner surface 34 of the vertical frame member 24. In one embodiment, the protruding portions 74 are constructed and arranged to fill the gap between the gasket member 44 and the inner surface 34 of the vertical frame member 24 and to allow for any deviations in thickness of the gasket member 44 and the vertical frame member 24.

Referring to FIGS. 6-10, in one embodiment, the frame member 24 further comprises a groove 48 constructed and arranged to receive and hold a weather stripping portion 50 for sealing the sliding door panel 18 against the fixed door panel 16. In one embodiment, the groove 48 is disposed on the integral connector portion 88.

In one embodiment, the weather stripping portion 50 is made from a soft and thick, fur or fur-like material. In another embodiment, the weather stripping portion 50 is made from a soft and thick, felt or felt-like material. In yet other embodiments, the weather stripping portion 50 is made from a soft, flexible rubber material.

FIGS. 7-9 illustrate the sliding door panel being slidably moved relative to the fixed door panel from the closed position to the open position (i.e., in the direction of sliding A) in accordance with an embodiment of the present invention. When the sliding door panel 18 is in the intermediate position (i.e., a position in between the closed position and the open position) as shown in FIGS. 7-10, resilient arm members 52 of the weather stripping portion 50 on the sliding door panel 18 are adapted to engage with (or rest on) a surface 54 of the fixed door panel 16.

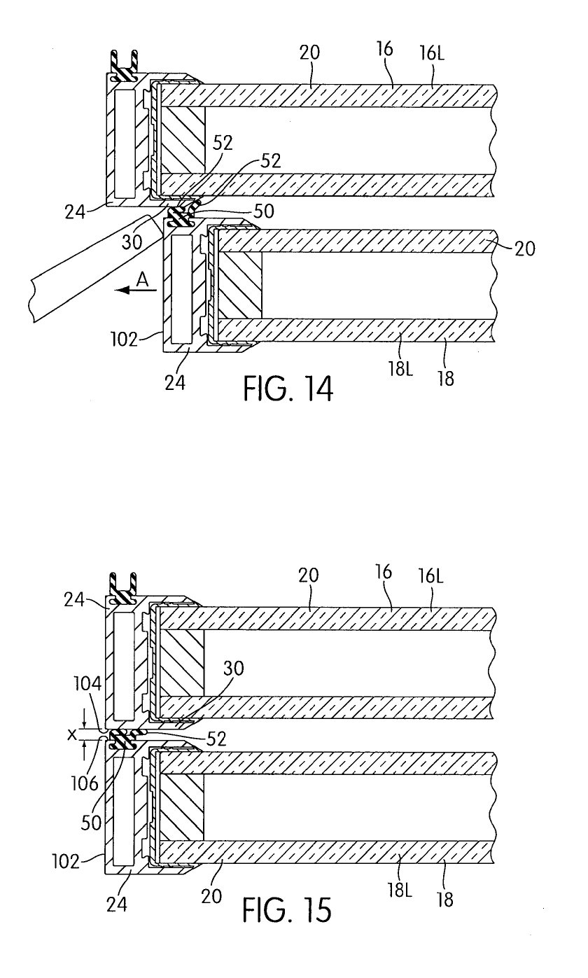

As the sliding door panel 18 is being moved to the open position (i.e., the sliding door panel 18 is in an overlapping relationship with the fixed door panel 16 in a manner that permits passage through the door opening 26) as shown in FIGS. 13 and 14, the resilient arm members 52 of the weather stripping portion 50 on the sliding door panel 18 come into contact with the gasket member 44 and the end portion 30 of the vertical frame member 24 of the fixed door panel 16. When the resilient arm members 52 of the weather stripping portion 50 on the sliding door panel 18 come into contact with the gasket member 44 and the end portion 30 of the vertical frame member 24 of the fixed door panel 16, the gasket member 44 and the end portion 30 of the vertical frame member 24 of the fixed door panel 16 are configured to compress or deform the resilient arm members 52 of the weather stripping portion 50 on the sliding door panel 18 to enable the sliding door panel 18 move into the open position.

Similarly, as the sliding door panel 18 is being moved to the closed position (i.e., the sliding door panel 18 covers at least a portion of the door opening 26 to prevent passage through the door opening 26), the resilient arm members 52 of the weather stripping portion 50 on the sliding door panel 18 come into contact with the gasket member 44 and the end portion 30 of the vertical frame member 24 of the fixed door panel 16. When the resilient arm members 52 of the weather stripping portion 50 on the sliding door panel 18 come into contact with the gasket member 44 and the end portion 30 of the vertical frame member 24 of the fixed door panel 16, the gasket member 44 and the end portion 30 of the vertical frame member 24 of the fixed door panel 16 are configured to compress or deform the resilient arm members 52 of the weather stripping portion 50 on the sliding door panel 18 to enable the sliding door panel 18 move into the closed position.

Even though the same weather stripping portion 50 on the sliding door panel 18 is being compressed or deformed in both the above discussed cases (i.e., when the sliding door panel 18 is being moved to the closed position and when the sliding door panel 18 is being moved to the open position), the vertical frame member 24 of the fixed door panel 16 that is compressing or deforming this weather stripping portion 50 is different in both the cases. For example, as the sliding door panel 18 is being moved to the closed position, the vertical frame member 24R (as shown in FIGS. 7-9) is configured to compress or deform the resilient arm members 52 of the weather stripping portion 50 on the sliding door panel 18. On the other hand, as the sliding door panel 18 is being moved to the open position, the vertical frame member 24L (as shown in FIGS. 7-9) is configured to compress or deform the resilient arm members 52 of the weather stripping portion 50 on the sliding door panel 18.

When the sliding door panel 18 is being moved in the direction of sliding A to the open position and an object is disposed between the vertical frame member 24 of the fixed door panel 16 and the vertical frame member 24 of the sliding door panel 18, the angled surface 38 of at least one of the vertical frame member 24 (i.e., the vertical frame member 24 of the fixed door panel 16) is constructed and arranged to prevent the formation of a pinch point between the door panels 16 and 18. The process by which the formation of a pinch point between the door panels 16 and 18 is prevented in the door assembly 10 is described in detail below with respect to FIGS. 10-14.

Referring to FIGS. 10-12, as the vertical frame member 24 of the sliding door panel 18 moves or slides in the direction of sliding A, the vertical frame member 24 of the sliding door panel 18 causes the object to engage with angled surface 38 of the end portion 30.

Further movement or sliding of the sliding door panel 18 in the direction of sliding A causes the object to slide downwardly in the direction B along the angled surface 38 of the end portion 30 of the fixed door panel 16.

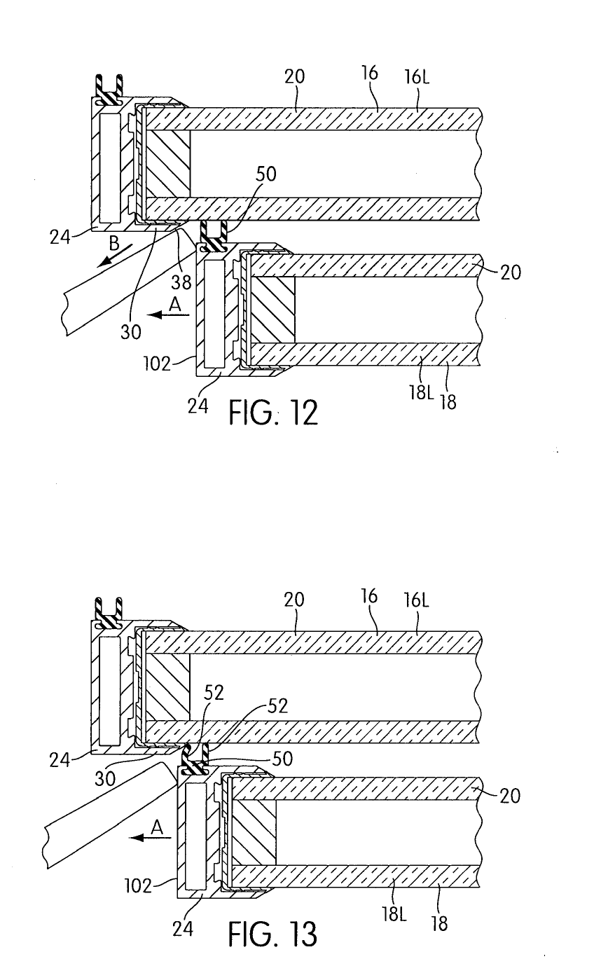

Referring to FIGS. 12 and 13, this downward sliding (in the direction B) of the object along the angled surface 38 of the end portion 30 of the fixed door panel 16 continues until the object is no longer in contact with the angled surface 38 of the end portion 30 of the fixed door panel 16. As shown in FIG. 13, once the object is moved out of contact with the angled surface 38 of the end portion 30 of the fixed door panel 16, the object is then moved away from between the door panels 16 and 18 by sliding movement of the vertical frame member 24 of the sliding door assembly 18 and thus preventing the formation of a pinch point of the object between the door panels 16 and 18.

Referring to FIGS. 13 and 14, as noted above, as the sliding door panel 18 is being moved to the open position, the resilient arm members 52 of the weather stripping portion 50 on the sliding door panel 18 come into contact with the gasket member 44 and then the end portion 30 of the vertical frame member 24 of the fixed door panel 16. When the resilient arm members 52 of the weather stripping portion 50 on the sliding door panel 18 come into contact with the gasket member 44 and the end portion 30 of the vertical frame member 24 of the fixed door panel 16, the gasket member 44 and the end portion 30 of the vertical frame member 24 of the fixed door panel 16 compress the resilient arm members 52 of the weather stripping portion 50 on the sliding door panel 18. As shown in FIG. 14, even when the sliding door panel 18 is in a partial overlapping relationship with the fixed door panel 16, a large clear door opening is provided by the door assembly 10.

FIG. 15 illustrates the sliding door panel 18 in a fully open position and is in a fully overlapping relationship (i.e., as opposed to being in a slightly offset overlapping relationship) with the fixed door panel 16. The fully overlapping relationship between the fixed door panel 16 and the sliding door panel 18 of the door assembly 10 provides a maximum clear door opening.

In one embodiment, when the sliding door panel 18 is an open position wherein the sliding door panel 18 is in a fully overlapping relationship with the fixed door panel 16 as shown in FIG. 15, an inner surface 104 of the vertical frame member 24 of the fixed door panel 16 is spaced apart or separated from an inner surface 106 of the vertical frame member 24 of the sliding door panel 18 by a distance of X (as shown in FIG. 15). In one embodiment, the distance between the inner surface 104 of the vertical frame member 24 of the fixed door panel 16 and the inner surface 106 of the vertical frame member 24 of the sliding door panel 18 is between 0.125 inches to 0.5 inches. In another embodiment, the distance between the inner surface 104 of the vertical frame member 24 of the fixed door panel 16 and the inner surface 106 of the vertical frame member 24 of the sliding door panel 18 is between 0.2 to 0.4 inches. In one embodiment, the distance between the inner surface 104 of the vertical frame member 24 of the fixed door panel 16 and the inner surface 106 of the vertical frame member 24 of the sliding door panel 18 is approximately 0.25 inches.

Also, when the sliding door panel is an open position wherein the sliding door panel 18 is in the fully overlapping relationship with the fixed door panel 16 (in a manner that permits passage through the door opening 26) as shown in FIG. 15, the resilient arm members 52 of the weather stripping portion 50 on the sliding door panel 18 are in a fully compressed configuration.

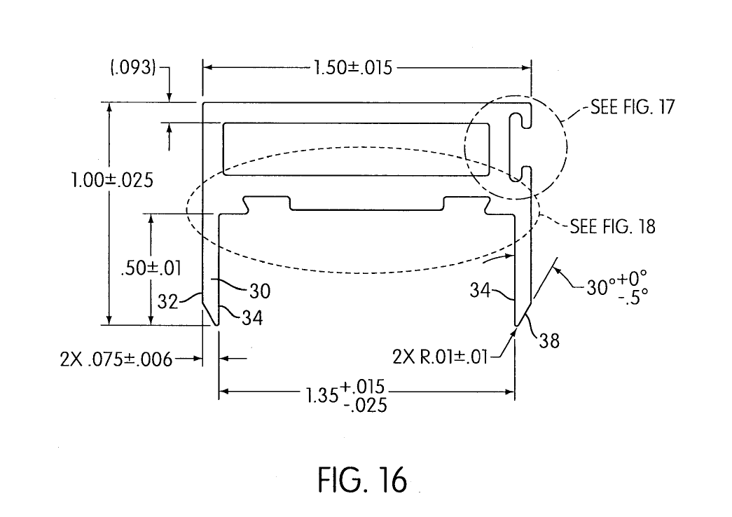

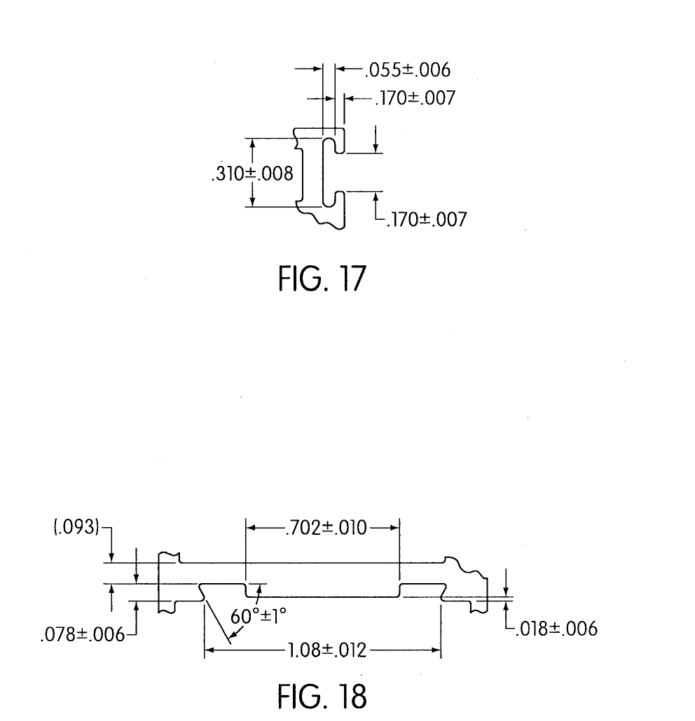

FIGS. 16-18 show portions and dimensions of various parts of an exemplary frame in accordance with an embodiment of the present invention. The portions and dimensions of various parts of the frame shown in FIGS. 16-18 are intended to be merely exemplary and not limiting in any way. The various parts of the frame shown in FIGS. 16-18 are drawn to scale in accordance with one embodiment, although other scales and shapes may be used in other embodiments. The dimensions of various parts of the frame as shown in FIGS. 16-18 are measured in inches unless indicated otherwise. In one embodiment, the dimensions of various parts of the frame, as shown in FIGS. 16-18, are up to 10 percent greater than or up to 10 percent less than those illustrated. In another embodiment, the dimensions of various parts of the frame, as shown in FIGS. 16-18, are up to 5 percent greater than or up to 5 percent less than those illustrated.

As shown, in one embodiment, the thickness of each end portion 30 (the distance between the surfaces 34 and 36) is about 0.075 inches. It is contemplated that for some embodiments, the thickness can be in the range of 0.065 to 0.085 inches. In another embodiment, the thickness can be in the range of 0.05 to 0.1 inch. It should be understood that these are non-limiting examples.

Also as shown, in one embodiment, the angle between the surfaces 34 and 38 is about 30 degrees. It is contemplated that for some embodiments, the angle between the surfaces 34 and 38 can be in the range of 20 to 40 degrees. In another embodiment, the thickness can be in the range of 10 to 45 degrees. It should be understood that these are non-limiting examples.

Also as shown, the surfaces 34 and 36 can be parallel to one another. However, in another embodiment, the surface 36 may taper towards the surface 34 as it approaches surface 38. In other embodiment, the surface 36 tapers all the way to surface 34 and there is no surface 38.

Also as shown, the radius of curvature of the corner portion 40 is between 0.003 and 0.04 inches. In another embodiment, the radius of curvature of the corner portion 40 is between 0.005 and 0.02 inches. In one embodiment, the radius of curvature is about 0.01 inches. In one embodiment, instead of having a radius of curvature, the corner portion 40 is either pointed (without radius of curvature) or is a flat ended surface.

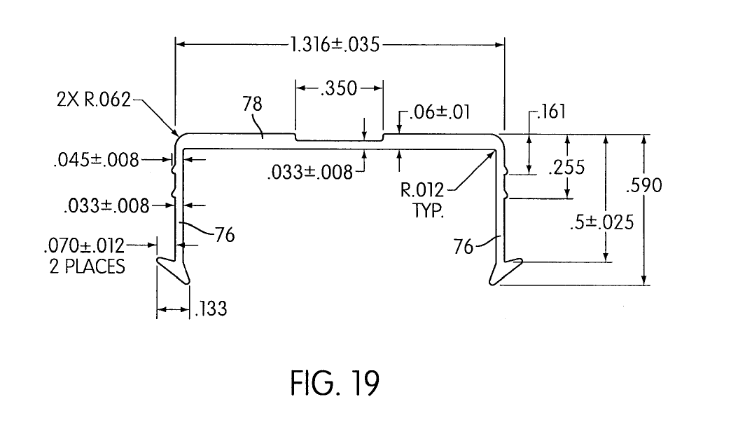

FIG. 19 shows portions and dimensions of various parts of an exemplary gasket member in accordance with an embodiment of the present invention. The portions and dimensions of various parts of the gasket member shown in FIG. 19 are intended to be merely exemplary and not limiting in any way. The various parts of the gasket member shown in FIG. 19 are drawn to scale in accordance with one embodiment, although other scales and shapes may be used in other embodiments. The dimensions of various parts of the gasket member as shown in FIG. 19 are measured in inches unless indicated otherwise. In one embodiment, the dimensions of various parts of the gasket member, as shown in FIG. 19, are up to 10 percent greater than or up to 10 percent less than those illustrated. In another embodiment, the dimensions of various parts of the gasket member, as shown in FIG. 19, are up to 5 percent greater than or up to 5 percent less than those illustrated.

In one embodiment, the present invention provides a method of glazing such that the glass panel of the each door panel is virtually flush to the frame surrounding it. The method of glazing disclosed in the embodiments of the present invention is a dry glazing method. Such dry glazing method may repeatable and may be easily accomplished in the field.

One skilled in the art will understand that the embodiment of the door assembly 10 shown in the figures and described above is exemplary only and not intended to be limiting. It is within the scope of the invention to provide any known door assembly with any or all of the features of the present invention. For example, the frame and/or the gasket member constructed according to the principles of the present invention can be applied to any known door assembly.

Although the invention has been described in detail for the purpose of illustration, it is to be understood that such detail is solely for that purpose and that the invention is not limited to the disclosed embodiments, but, on the contrary, is intended to cover modifications and equivalent arrangements that are within the spirit and scope of the appended claims. In addition, it is to be understood that the present invention contemplates that, to the extent possible, one or more features of any embodiment can be combined with one or more features of any other embodiment.

What is claimed is:

1. A door assembly comprising:
a fixed door panel constructed and arranged to be fixed in a door opening;
a sliding door panel constructed and arranged to be slidably movable relative to the fixed door panel between (1) a closed position wherein the sliding door panel covers at least a portion of the door opening to prevent passage through the door opening and (2) an open position wherein the sliding door panel is in overlapping relationship with the fixed door panel in a manner that permits passage through the door opening,
each door panel includes
a glass panel; and
a frame including a vertical frame member constructed and arranged to surround at least a portion of the vertical edge of the glass panel;
wherein at least one of the vertical frame members comprises an end portion having an angled surface extending inwardly towards the glass panel, and
wherein, as a result of movement of the sliding door panel, the end portion of the at least one vertical frame member at least partially overlaps another of the vertical frame members.

2. The door assembly of claim 1, wherein the fixed door panel is constructed and arranged to be releasably fixed in the door opening.

3. The door assembly of claim 1, wherein the end portion comprises a first surface adjacent the glass panel, and an opposing second surface separated from the first surface.

4. The door assembly of claim 3, wherein the first surface and the second surface are parallel to one another.

5. The door assembly of claim 3, wherein the first surface is separated from the second surface by the angled surface

6. The door assembly of claim 3, wherein distance between the first surface and the opposing second surface is between 0.05 and 0.1 inch.

7. The door assembly of claim 6, wherein the distance between the first surface and the opposing second surface is 0.075 inch.

8. The door assembly of claim 3, wherein the angled surface is oriented at an acute angle with respect to the first surface.

9. The door assembly of claim 8, wherein the angle between the angled surface and the first surface is between 20 and 45 degrees.

10. The door assembly of claim 9, wherein the angle between the angled surface and the first surface is about 30 degrees.

11. The door assembly of claim 3, the end portion further comprises a corner portion at an intersection between the angled surface and the first surface, and the corner portion having a radius of curvature is between 0.003 and 0.04 inches.

12. The door assembly of claim 11, wherein the radius of curvature of the corner portion is about 0.01 inches.

13. The door assembly of claim 1, wherein the frame member further comprises a groove constructed and arranged to receive and hold a weather stripping portion for sealing the sliding door panel against the fixed door panel.

14. The door assembly of claim 1, wherein distance between the vertical frame member of the fixed door panel and the vertical frame member of the sliding door panel is between 0.125 inches to 0.5 inches.

15. The door assembly of claim 14, wherein the distance between the vertical frame member of the fixed door panel and the vertical frame member of the sliding door panel is 0.25 inches.

16. The door assembly of claim 1, further comprising a gasket member constructed and arranged to be disposed between the glass panel and the frame member, wherein peripheral edge portion of the gasket member is constructed and arranged to extend outwardly and partially engage with the end portion of the frame member.

17. The door assembly of claim 16, wherein the frame member comprises a generally U-shaped channel constructed and arranged to receive the gasket member therein.

18. The door assembly of claim 16, wherein the gasket member has a generally U-shaped cross-sectional configuration to receive the glass panel therein.

19. The door assembly of claim 16, wherein the gasket member is made from a Thermoplastic Rubber (TPR) material or a Thermoplastic Elastomer (TPE) material.

20. The door assembly of claim 1, wherein the frame member is made from an aluminum material.
